(19) United States
(12) Patent Application Publication
(10) Pub. No.: US 2010/0158076 A1
(43) Pub. Date: Jun. 24, 2010

(54) Direct Sequence Spread Spectrum Correlation Method for a Multiprocessor Array

(75) Inventors: Les O. Snlyely, Castle Rock, CO (US); Paul Michael Ebert, Lansdowne, VA (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/340,486

(22) Filed: Dec. 19, 2008

(51) Int. Cl. H04B 1/00; G06F 15/76; G06F 9/06

(52) U.S. Cl. 375/130; 712/11; 712/E09.003

(57) ABSTRACT

A method and apparatus for correlation of a received DSSS signal with a PN sequence, thus significantly reducing the processing time and operating power needed to acquire phase information for DSSS de-spreading and demodulation. The apparatus utilizes a multiprocessor array 10. In one embodiment, multiple processors 15 are located on a single-die 25, connected by single drop busses 20 to form low-operating-power apparatus. The method provides for fast sequential correlation of a received digital signal. In an alternate embodiment, the present invention is a single-die, low-operating-power apparatus and method for fast parallel correlation of a received digital signal. In yet another alternate embodiment, the present invention is a single-die, low-operating-power apparatus and method for fast correlation of a received digital signal using a hybrid of parallel and sequential methods.

### BACKGROUND OF THE INVENTION

1. Field of the Invention

The present invention relates generally to the field of digital communications, and more particularly to a single-microchip multiprocessor apparatus and method for acquiring and demodulating a direct sequence spread spectrum waveform, such as those utilized in handheld and portable wireless communication devices.

2. Description of the Background Art

Direct sequence spread spectrum (DSSS) modulation is used in many communication systems, including the GPS positioning system, GSM cell phones, many forms of the WiFi standard, and some wireless home telephone implementations. Digital signal processing operations are employed in these operations. Such applications require substantial processing and silicon resources. DSSS modulation is accomplished by multiplying (also called spreading or modulating) a digital information signal by a binary pseudo-random code sequence (also called pseudo-noise (PN) sequence, or key) at a high rate (also called the “chipping” rate) which is an integer multiple of the binary data rate of the digital information signal (also called symbol rate), to produce a “spread” information signal (also called baseband signal). The spread signal, has a data rate much faster than the original digital information signal. The spread signal then modulates an RF carrier. The resulting RF signal has a wider bandwidth than the data signal alone, and can be spectrally equivalent to a noise signal.

DSSS demodulation occurs at a receiver. The first step includes de-spreading. The de-spreading is accomplished by multiplication of the input with a locally generated copy of the PN sequence. Owing to timing uncertainties from channel propagation delay, and clock, phase, and carrier frequency shifts between transmitter and receiver, acquiring the correct timing is a key part of the de-spreading process and requires correlating PN sequences at high speed. Typical PN sequence lengths range from 7 to 1023 coded bits (also called “chips” in spread spectrum terminology) per information signal bit. Longer sequences can also be used. The challenge when building a spread spectrum communication system is two fold—acquiring the initial timing of the PN sequence, and then de-spreading (demodulating) the spread signal associated with the sequence. The acquisition process is the hardest and most processor intensive of the two. Even though DSSS offers significant advantages of very high spectral efficiency and simple network management, it is not as widely used as it could be, primarily because acquiring and de-spreading a received PN signal is processor intensive. Several techniques for acquisition and de-spreading are known in the art, such as serial active correlation and parallel correlation (also termed matched filtering); but serial implementations are slow, requiring a long acquisition time, and parallel implementations, while faster, have reached a point of diminishing returns owing to inherent speed limitations of prior art processor cores and their interconnectivity, and because only a relatively small number of cores have been readily available on a single microchip, also called a die.

However, advances in semiconductor technology have enabled more and faster circuits that can operate with lower power consumption to be placed in a given die area, and advances in microprocessor architecture have provided single-die multiprocessor array, and stacked-die array, type computer systems in extremely compact form with capabilities for processing signals enormously faster and with very low operating power. One known form of such a computer system is a single-die multiprocessor array, comprising a plurality of substantially similar, directly-connected computers (sometimes also referred to as “processors”, “cores” or “nodes”), each computer having processing capabilities and that may or may not have at least some dedicated memory, and adapted to operate asynchronously both internally and for communicating with other computers of the array and with external devices. Moore, et al. (U.S. Pat. App. Pub. No. 2007/0250682 A1) discloses such a computer system. Operating speed and power saving improvements provided by such computer systems can be advantageous for signal processing application, especially in portable configuration.

Thus, a novel approach, taking advantage of new multiprocessor array technology mentioned above, can be used to improve DSSS demodulation speed and reduce power consumption.

### SUMMARY OF THE INVENTION

Accordingly, it is an object of the present invention to provide an improved apparatus and method for faster processing of received communication signals which use DSSS modulation. More particular objects of the invention are to acquire timing information for de-spreading a received DSSS signal with increased operating speed and reduced electrical power consumption, and with a circuit that has a small area suitable for embedding on a single die.

Briefly, the present invention is an improved apparatus and method utilizing a multiprocessor array for correlation of a received DSSS signal with a PN sequence, thus significantly reducing the processing time and operating power needed to acquire phase information for DSSS de-spreading and demodulation.

In one embodiment, the present invention is a single-die, low-operating-power apparatus and method for fast sequential correlation of a received digital signal. In an alternate embodiment, the present invention is a single-die, low-operating-power apparatus and method for fast parallel correlation of a received digital signal. In yet another alternate embodiment, the present invention is a single-die, low-operating-power apparatus and method for fast correlation of a received digital signal using a hybrid of parallel and sequential methods.

### BRIEF DESCRIPTION OF THE DRAWINGS

FIG. 1 is a block diagram of an array correlator according to an embodiment of the invention, for application in demodulation of a DSSS signal;

FIG. 2 is a flow diagram of operation of an array correlator for DSSS timing acquisition according to a first embodiment of the method of the invention, using a threshold value to assess correlation;

FIG. 2A is a symbolic diagram illustrating relative index positions of shifted 7-bit reference PN sequences in a data stack register of a correlation computer, according to an alternate version of the sequential acquisition embodiment of FIG. 2;

FIG. 3 is a flow diagram of operation of an array correlator for timing acquisition, according to a second embodiment of the inventive method, using shifted PN sequences stored in a stack;

FIG. 4 is a flow diagram of operation of an array correlator for DSSS timing acquisition, according to a third embodiment of the inventive method, examining all relative alignments to assess correlation;

FIG. 5 is a flow diagram of operation of an array correlator for parallel timing acquisition, using rotated PN reference words, according to a fourth embodiment of the method of the invention;

FIG. 5A is a flow diagram of operation of an array correlator for parallel timing acquisition according to an alternate embodiment of the method of FIG. 5, using shifted PN reference words and a longer received data segment;

FIG. 6 is a symbolic diagram illustrating rotated positions of shifted 7-bit reference PN sequences in a data stack register of 7 correlation computers, according to the parallel acquisition embodiment of FIG. 5;

FIG. 7 is a symbolic diagram illustrating relative index positions of shifted reference PN sequences longer than a register, in series of 4 or 5 data stack registers, according to the parallel acquisition embodiment of FIG. 5;

FIG. 8 is a symbolic diagram illustrating relative index positions of shifted reference PN sequences longer than a register, in series of 4 or 5 data stack registers, according to a fifth, hybrid acquisition embodiment of the method of the invention.

### DETAILED DESCRIPTION OF THE INVENTION

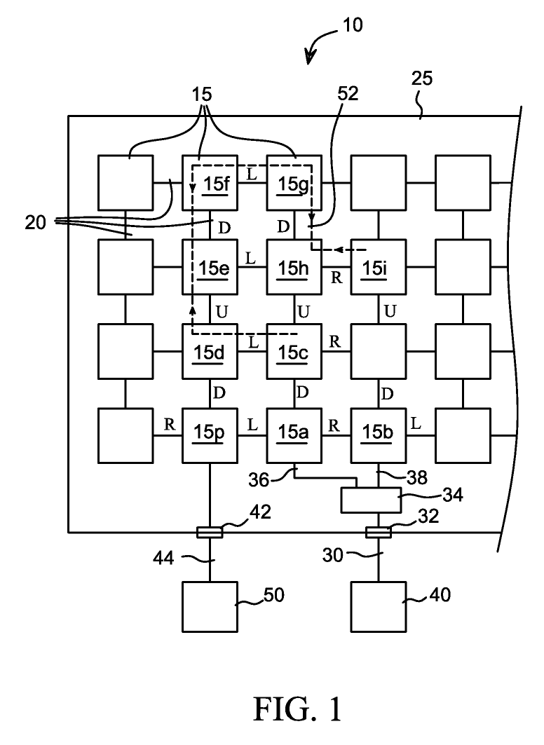

An apparatus for carrying out the invention is an array correlator depicted in a diagrammatic view in FIG. 1 and designated therein by the general reference character 10. In a first embodiment utilizing a portion of a SEAforth® Scalable Embedded Array™ Processor, which is presently known in 24-processor and 40-processor versions, the array correlator 10 can include a plurality of general-purpose computers 15, which are located on a single die (microchip) 25, a portion of which is shown in FIG. 1. For a better understanding of the invention, it will be useful first to describe the characteristics of a SEAforth® array used in this embodiment in more detail; it should be noted, however, that the invention is not limited to implementation with a SEAforth® array, or a single die, and may be practiced with equal effect in alternate embodiments using other suitable array processors and circuits. Each of the computers 15 of a SEAforth® array is a general purpose, independently functioning computer, which has an 18-bit binary computer word size, and which is directly connected to each of its physically closest neighboring computers, as shown in the figure, by a single drop data and control bus 20, that includes 18 data lines and 2 control lines. The direction port designations R, D, L, U, used for communication between computers 15, are indicated in the figure. In the SEAforth® embodiment, data and instructions are communicated asynchronously between the computers, and there is no common bus over which an individual computer 15 can be addressed; also, the internal operation of each computer 15 is asynchronous and there is no local system clock in a computer, but sequencers are employed. In addition, each computer 15 has its own local memory, including, for example, read only memory (ROM) and random access memory (RAM), which can hold substantially the major part of its program instructions, including the operating system. The computers 15 are adapted to execute native (machine) Forth language instructions and to use Forth words (also known as subroutines and programs), dictionaries of Forth words, and forthlets, sometimes collectively referred to as “Forth code”. Each computer 15 has a plurality of hardware registers (also referred to as “stacks”) including two stacks, respectively, called data stack and return stack, wherein the data stack includes two fixed registers followed by eight “circular” registers, and the return stack includes one fixed register followed by eight “circular” registers. The circular register portion of a stack provides automatic cyclical overwriting after storing (writing) a fixed number of consecutive computer words to the stack, and indefinte cyclical re-storing of data that is retrieved (read) from the circular portion, at every reading from the stack. Communication with external devices is implemented through input/output (I/O) ports connected to peripheral computers of the array, according to the application. In the embodiment shown in FIG. 1, the array correlator 10 has I/O connections to two external devices 40, 50, one for primarily signal communcation and the other for primarily control communication, as will be presently described in greater detail hereinbelow.

One example of a DSSS signal is a quadrature-modulated RF signal that can be demodulated and separated in the receiver into two parallel spread signal streams termed an in-phase (I) component and a quadrature-phase (Q) component, which are separately processed for de-spreading, and which carry independent signal information. A spread signal stream is a binary digital signal, with the bit values sometimes referred to as signal chips, and having a baseband bit rate corresponding to the chipping (spreading) rate used at the transmitter. It should be noted that the I and Q components are both simultaneously processed into a spread spectrum signal at the transmitter using one and the same PN sequence, and hence require the same PN sequence for demodulation. It can further be noted that the I and Q signals can also be conventionally considered as the real and imaginary parts of a complex I/Q value, and processing two such data streams in parallel is sometimes also referred to as complex processing.

Another common example of a DSSS signal is a binary-modulated RF signal employing phase inversion (180 degrees) to code binary 1s and 0s that can be demodulated in the receiver into one binary digital spread signal stream.

A third example would be the use of DSSS modulation on an optical carrier, using either on-off keying, or additional modulation of the optical carrier.

In one embodiment of the invention, signal communication of array correlator 10 with external device 40 can be adapted to be operative in form of analog signals in the RF range of frequencies, and can proceed through external connection means 30, I/O port 32, an additional I/O circuit 34, connections 36, 38, and peripheral computers 15a, 15b. The I/O port 32 can be an analog RF port; and there can be an additional I/O circuit 34 on the die 25, interposed between peripheral computers 15a, 15b and the I/O port 32, in the signal path. Circuit 34 can include a RF front end circuit operative to demodulate I and Q phases of a quadrature-modulated signal and input these to computers 15a and 15b, respectively; and computers 15a and 15b can be adapted to perform analog-to-digital conversion (ADC), and can be operative to generate the I and Q digital spread signals.

In an alternate embodiment, the circuit 34 can be adapted to perform ADC, and can be operative to input two parallel spread signal streams to computers 15a, 15b for digital demodulation and generation of the I and Q signals. It will be recognized by those skilled in the art that in the alternate embodiment, a plurality of other computers 15 can be adapted (for example, by suitable programs of Forth instructions) to assist computers 15a, 15b in performing the digital demodulation and generation of the I and Q signals. Other associated digital processing functions, such as Direct Digital Synthesis of appropriate waveforms for digital demodulation, generation of sampling signals for ADC, and the like, which are not shown, can be performed by other computers 15 of the array, and suitably connected to the circuit 34, and communicating with the plurality and with computers 15a, 15b.

In still an alternate embodiment, the RF front end-circuits can be included in external device 40 and not on die 25, and the I and Q spread signals can be provided to array correlator 10 via two separate digital I/O ports 32, in parallel, in form of digital serial communication.

Owing to an 18-bit computer word size in the first embodiment, a binary data sequence up to 18 bits long can be handled as a multi-bit segment in one computer word, with the remaining bits of a shorter than 18-bit segment suitably specified, as convenient; in alternate embodiments, the computer word size can be different and a data segment of different length can be held in one computer word. It should be noted that in the receiving direction, a spread signal stream can be de-serialized (in suitable peripheral computers) in 18-bit or smaller segments into the top (T) register of the data stack, and in the transmitting direction, serialized out of the T-register, and in both directions otherwise handled in multi-bit binary signal segments (computer words) on data buses and in registers on chip 25. It should be further noted that in the operation of array correlator 10, data and instructions can be transmitted from external device 40 and 50 also to a non-peripheral computer 15, and to a plurality of computers 15, and in that case the data path can include a peripheral computer, and non-peripheral computer(s), through which the data can be passed, by using suitable streaming and loading instructions and also special circuit portions on chip 25 not included in a computer 15, such as I/O circuit 34.

In the embodiment shown in FIG. 1, a second I/O port 42 is provided for connecting peripheral computer 15p by connection means 44 to a second external device 50, for convenient control communication and loading of digital data such as a reference PN sequence, as will be described in greater detail hereinbelow.

There are a great many other ways in which the front-end circuits of a DSSS receiver and an array correlator can be arranged without departing from the spirit and the method of the invention.

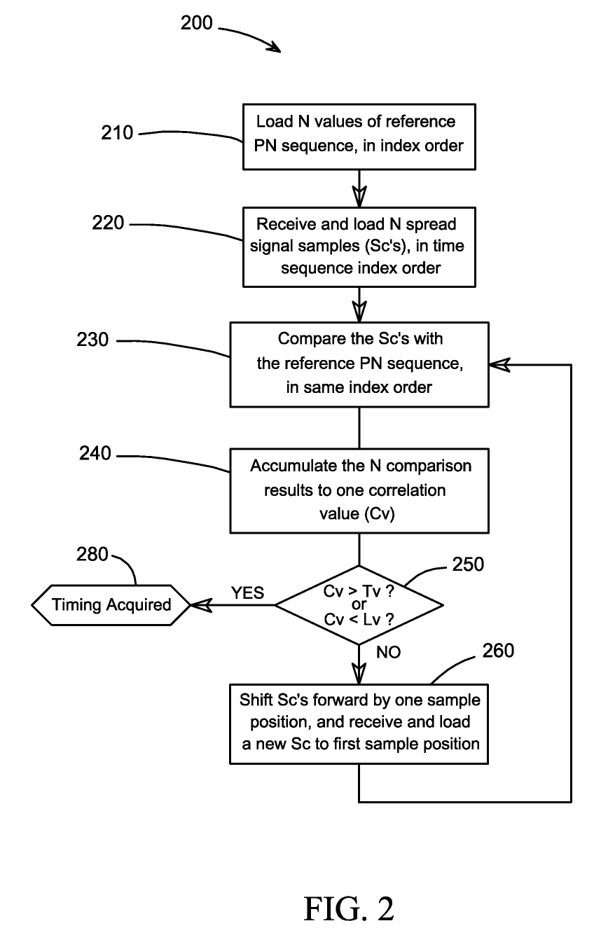

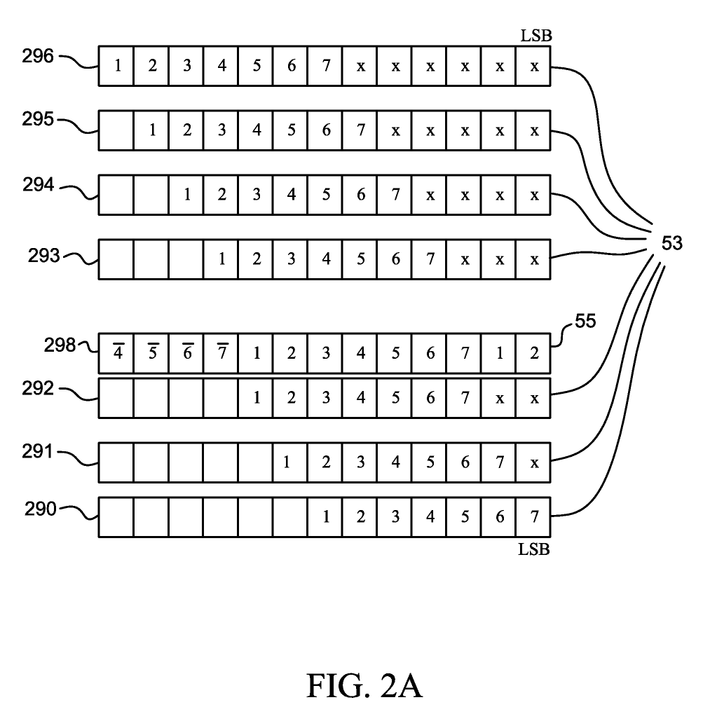

FIG. 2 is a flow diagram illustrating operation of the array correlator 10 illustrated in FIG. 1, as are all hardware described in this and later discussions, according to a first sequential acquisition embodiment of the method of the invention. The method is described by a sequence of signal processing steps 200. Quadrature modulation will be assumed for purposes of description, but the method is applicable with suitable simplification and modification also for acquisition and demodulation of a binary-modulated signal, with equal effect. These and other RF modulation techniques differ from each other with respect to acquisition and demodulation, principally by the number of independent parallel spread signal bit streams, which can be processed generally in the manner described hereinbelow with reference to I- and Q-component spread signal streams, and with reference to the one spread signal stream associated with binary modulation.

In step load 210, N predetermined reference PN sequence values (bits), which are used in the transmitter that produces the received DSSS signal, are loaded into computer 15p of array correlator 10, for example from an external flash memory device 50, as part of an activation procedure, or other external device at a factory service facility, and for example by de-serializing into the data stack. In some applications of DSSS technology, such as CDMA communication systems, it is advantageous to use a PN sequence length N=2^{M}−1, where M is a positive integer, and the examples presented hereinbelow will be chosen accordingly; however, other values of N, such as even integer values, may be preferred in other applications, and may be used with equal effect in the embodiments described. The PN sequence values are loaded in the same sequential index order, 1 to N, used in the transmitter, to a register of the stack, starting with the least significant bit (LSB) position (also referred to as bit position 0 according to SEAforth® terminology) and shifting previous values up toward MSB as new PN values with higher sequential index value are filled into the register. The reference PN sequence can also be stored in RAM; and alternatively, according to the application, a predetermined reference PN sequence can be loaded into ROM at time of manufacture, or later, at a factory service facility. In this embodiment, the PN sequence will be assumed to have, for example, a length of 7 bits (M=3), and accordingly, can be loaded from external device 50 into the T-register of computer 15p, so that the (first) PN bit having PN sequence index 1 will be at bit position 6 of the register, the bit having index 2 will be at bit position 5, and so on, and the (last) bit having index 7 will be at bit position 0, in the register. Two 7-bit reference PN sequences can be concatenated into a 14-bit PN word (the use of which will be presently described hereinbelow), and transmitted to computer 15c, in the first embodiment, by suitable machine Forth instructions (operative in a SEAforth® array). In this embodiment, the PN word will stay in the T-register of computer 15c until it gets pushed down into the S-register when the next item is placed in the data stack, in the next step of operation.

In step receive 220, a segment of the received spread signal, also referred to as a subset of input data, comprising the first N I/Q signal samples (chips), in this example, 7 I-values and 7 Q-values, are transferred (received, read in) from the external device 40 to the array correlator 10, in time sequence index order 1 to 7, and in the first embodiment, are loaded to the data stack T-registers of computers 15a and 15b, respectively, filling the registers from LSB toward MSB, in the same order as the reference PN sequence, as described hereinabove, in step 210. It should be noted that register filling can alternatively be performed in opposite order, from MSB toward LSB, as desired, as long as it is the same index and bit position order for both the reference PN sequence and the spread signal. The 7-bit segment of the I-component spread signal and the parallel 7-bit segment of the Q-component spread signal can be combined (concatenated) into one 14-bit spread signal word (having 14 significant bits), which can be, herein also referred to as the I/Q word (sometimes also called the complex I/Q value), in computer 15a and transmitted to computer 15c, again for example by a suitable Forth program. Storing one value of I and Q in each signal word is only one of many ways in which the values could be stored, and others may be used as needed for the application at hand. At the end of step 220 in this embodiment, the I/Q word will be in the T-register and the PN word, in the S-register of the data stack of computer 15c, appropriately aligned for bit-by-bit comparison in the next step 230 of operation presently described hereinbelow.

It should be noted that the reference PN sequence values, when taken in the order described, represent an ideal spread signal segment that is desired to be observed in the signal received from external device 40. In practice, a received signal segment, sometimes also called a subset of input data, will likely never match exactly with the reference PN sequence, primarily due to noise during transmission, and hardware imperfections. However, by processing the incoming spread signal according to a correlation algorithm, it can be estimated whether or not a match is within an acceptable tolerance limit of alignment with the reference PN sequence (also referred to as exceeding a “threshold value” Tv of correlation). For the example of a quadrature-modulated RF signal, the I and Q components carry independent signal information, and thus the I and Q components can be handled for processing as concatenated computer words; in such case, there can be four types of match of an I/Q word with a concatenated PN word, corresponding to de-spread digital information values (Ids, Qds) from the set {(1,0), (1,1), (0,0), (0,1)}. A concatenated PN word wherein both PN portions are identical, can produce a match with an ideal received signal segment having (Ids,Qds)=(1,1), and a match with an ideal segment having (Ids,Qds)=(0,0), which can also be called “anti-match” with (Ids,Qds)=(1,1) as will be further described hereinbelow. In order to find a match (or anti-match) with an ideal segment having (Ids,Qds)=(1,0) or (0,1), a “conjugate” concatenated PN word comprising a reference PN sequence and its complement can be used. The conjugate PN word can be formed in step 210 by inverting the bits of the second reference PN sequence, before concatenating the double PN word. When a match or best alignment occurs, the signal, and more specifically its timing, is said to be “acquired”, and the acquisition process, according to the invention, is complete. An embodiment of an acquisition process with substantially digital implementation is described in more detail in the following steps; however, in an alternate embodiment, a higher performance analog approximation could be implemented as well.

In step compare 230 a spread signal word (in this embodiment, the I/Q word) is compared bit-by-bit with the PN word, in the same index order. Owing to concatenation of the I and Q-components, and concatenation of the PN sequence into a double PN word (in steps 220 and 210), both components can be compared with the PN sequence substantially at the same time, in parallel, by one logical operation involving two registers. In this embodiment, the comparison can be accomplished by an XOR instruction (of the SEAforth® array), operating on the spread signal word in the T-register of the data stack in computer 15c, and on the PN word in the S-register of the data stack in computer 15c, which leaves a comparison word containing two concatenated 7-bit comparisons in the T-register. It should be noted that although the timing uncertainty of the I and Q-components can be substantially the same and either component could in theory be used for acquisition, using both components doubles the signal power available for processing and is therefore preferable. The comparison word will have a binary value of 1 in the bit positions wherein the values of the PN word and the signal word coincide, i.e., both have the same value 1 or 0, and an 0 in the bit positions wherein they have opposite values, i.e., one is 1 and the other is 0.

In accumulation step 240, the comparisons are accumulated to a correlation value Cv by a suitable bit counting program.

The correlation value Cv can be compared in branch test step 250 to a predetermined threshold value Tv, to assess the degree of correlation and determine if the signal is acquired, and a branch decision is made. Alternatively, in step 250 a two-part comparison can be performed, to test for Cv exceeding an upper threshold value Tv, indicating a match with (Ids,Qds)=(1,1), and for Cv lying below a lower threshold value Lv, indicating an “anti-match” with (Ids,Qds)=(1,1), that is, a match with (Ids,Qds)=(0,0). Still alternatively, comparison of the I/Q word also with the conjugate PN word may be included in steps 230, 240, and 250; this can be useful here for reducing the acquisition time still further (whenever the de-spread (Ids,Qds) values (1,0) or (0,1) occur before (1,1) or (0,0) in the received I/Q spread signal).

If in step 250 the correlation does not exceed the threshold (or lie below the lower threshold), the seven I and Q signal chips (Sc's) in the T-registers of computers 15a, 15b are updated, in the shift step 260, by shifting each of them forward (toward MSB) in the register by one bit position, and filling a new signal chip into LSB (SEAforth® bit position 0), thus providing a new subset of input data for comparison. It should be noted that a signal chip (and PN sequence value) can alternatively have multi-bit representation, such as, for example, two samples per chip, and in that case N two-sample values of the reference PN sequence would be loaded in load step 210, N two-sample spread signal chips (values) would be received in receive step 220, and the shifting in shift step 260 would be performed 2 register sample positions at a time. Returning to the example of 1 bit per received spread signal sample, referred to as a chip, the signal chip having time sequence index 1 and currently at bit position 6 is shifted out (discarded), the one having time sequence index 2 and currently at bit position 5 is shifted to bit position 6, and so on, and the one having time sequence index 7 is shifted to bit position 1, and a new signal chip (having time sequence index 8) is received from external device 40 and transferred bit position 0 in the T-register. In case of multi-bit representation, the term “bit position” used hereinabove should be interpreted as “sample position”. In this embodiment of the method, the reference PN values, however, remain at their initial bit positions in the register (or memory location) throughout the acquisition process. Then operation loops back to step 230, and the steps 230 through 250 are repeated.

While in many applications a repeated single symbol chip sequence is available during acquisition, it is desirable in some applications to acquire an arbitrary signal in the middle of transmission. It will be recognized by those familiar with the art that an arbitrary segment of N sequential bits of a received spread signal can span an information signal transition 1-to-1, 1-to-0, 0-to-1, or 0-to-0, and therefore, a segment length of at least 2N-1 bits is required to be certain of including a complete N-bit spread chip sequence that can match or anti-match an N-bit reference PN sequence.

In an alternate embodiment of the FIG. 2 method, the reference PN sequence, rather than the received chip sequence, could be shifted forward one bit position per cycle, in shift step 260, as illustrated in FIG. 2A for the case of N=7 and a sequence of cycles or passes through shift step 260, so that in each pass the value in bit position 0, denoted by LSB in the figure, is shifted to bit position I (to the left, in the figure); the value in position 1, to position 2; and so on, and the value in bit position 6 is also shifted forward to bit position 7 (and not rotated circularly back to bit position 0), and so on, and an arbitrary value, denoted by x in the figure, is loaded into bit position 0. The S-register 53 holding the reference PN sequence is depicted in FIG. 2A, before the first pass, as identified by the reference numeral 290, and after 6 consecutive passes, as identified by reference numerals 291-296. In the figure, the numbers in the boxes denote the PN sequence indices of the values at each bit position, and a bar over the numeral denotes a complement value at that position. In this embodiment, a received spread signal segment of 2N-1 (I-component or Q-component) chips, rather than the reference PN sequence, is held in their initial bit positions during the acquisition process. Accordingly, the shifted PN words in this embodiment will comprise an increasing number of bits (starting with N bits and up to 2N-1 bits) with each cycle or pass through step 260, and the bit counting program in step 240 is adapted to accumulate only the comparison results of the highest N bit positions of a respective shifted PN word, and to ignore the rest, for Cv calculation. It is advantageous in this embodiment to handle the I and Q components in separate computer words, rather than concatenated, and to keep their comparisons and determinations of Cv, in steps 230 and 240, separate. An example of a 2N-1=13 bit received (I or Q component) spread signal segment 298 in T-register 55 that has a 1-to-1 baseband (information) signal transition in bit position 2 and a 1-to-0 baseband transition in bit position 9 is shown in FIG. 2A, aligned with the second shifted reference PN sequence 292 in the S-register.

The Timing Acquired condition is asserted in end step 280, when in step 250 the correlation value is greater than the threshold value, or alternatively, below the lower threshold value, signifying completion of the timing acquisition process, i.e., that the approximate match of the spread signal stream with the reference PN sequence, or alternatively with its complement, occurs at the current relative index position (also referred to as “phase”), existing after the last forward shift was performed in step 260.

In the FIG. 2 method, each further received segment of N signal chips (in this embodiment, 7 signal chips) of the I component, and likewise of the Q component, represents one of the two binary states of the respective information signal before spreading, which can be identified as 1 or 0 by performing bit-by-bit comparison and accumulation operations generally as in steps 230 and 240, but without concatenation, separately for the I and Q components, and determining if the (now 7-bit) correlation value is greater than an upper threshold value Tv, indicating a binary value, for example 1, or less than a lower threshold value Lv, indicating the complement of the binary value, for example 0. A de-spread digital information signal can be generated accordingly, and further demodulated and reconverted to analog signals, according to the modulation technique employed at the transmitter, according to the application. Thus, after acquisition the spread signal can be read in and processed for de-spreading in segments of N signal chips at a time. Alternatively, the I and Q components can be processed for de-spreading in concatenated form as described hereinabove, with two comparisons and two branch tests performed on each concatenated 2N bits long I/Q word, to identify its (Ids,Qds) value as one of the four complex values (1,1), (1,0), (0,1), (0,0) of the information signal, as described hereinabove.

While a FIG. 2 illustrates a first embodiment of a method for processing a PN sequence of length 7, utilizing a single computer of a SEAforth® array (in this embodiment, computer 15c) to perform correlation, has been described, an alternate embodiment the same method can be extended to correlate input data for longer PN sequences that span a plurality of computer words. The PN sequence can be divided into portions, which can be loaded into a series of registers in the plurality of correlation computers of the array on die 25, herein referred to as a set of word-extension computers, and the portions can be processed in parallel in the computers, generally in the same manner as described hereinabove for computer 15c. A plurality of computers utilized in this manner according to the invention in effect extends the word size of an embodiment of the array correlator by means of software.

Accordingly, an alternate embodiment, for example for processing a PN sequence of length 63 bits (M=6) for spread spectrum signal acquisition, can operate substantially according to the sequence of steps 200 shown in FIG. 2, with appropriate changes owing to a longer PN sequence made as described hereinbelow, with reference also to FIG. 1. In the first step 210 of operation of the alternate embodiment, the 63-bit reference PN sequence can be divided into 7 consecutive PN portions of 9 bits each, as the reference PN sequence is loaded from external device 50 into computer 15p. A PN sequence (and a received spread signal segment) can be divided into smaller portions of consecutive bits in a great many alternative ways, which are limited by the size of the computer word used, and whether or not parallel modulation components such as the I and Q components are concatenated into one computer word, and by the number of computers available for processing; for example a 63-bit reference PN sequence could alternatively be divided into 8 consecutive portions, seven of which are 8 bits long and the last one, 7 bits long, and still alternatively it could be divided into 4 portions, three of which are 18 bits long and the fourth, 9 bits long. Each PN portion can be loaded into a stack register in increasing index order, starting with the lowest index value going first to the LSB (bit position 0), and then shifted consecutively to higher bit positions toward MSB, as PN bit values with higher sequence index are serially loaded to the LSB position, substantially as described hereinabove for the first embodiment of the method, for N=7. Each 9-bit PN portion can be concatenated into an 18-bit double PN portion word, and the 7 concatenated PN portion words can be distributed (transmitted) in sequential index order to a series of S-registers in a set of 7 computers 15c through 15i, herein referred to as word-extension computers, which are also correlation computers. The series of registers can be filled, for example, by loading PN portion words in increasing index order, first into computer 15c, and shifting the words consecutively toward computer 15i along a communication path 52 identified in FIG. 1, which spans the set of word-extension computers; so that the PN portion word for sequence indices (index values) 1 through 9 will be in a register of the stack in computer 15i, in bit positions 8 through 0, respectively, (and by concatenation also in bit positions 17 through 9); the PN portion word for indices 10-18 will be in computer 15h, in bit positions 8-0; and so on, and the PN portion word for indices 55-63 will be in computer 15c, in bit positions 8-0.

In step 220, for a quadrature-modulated signal (with independent I and Q components), the first N I/Q spread signal chips, in this embodiment 63 I-values and 63 Q-values, can be transferred from external device 40 to the data stack T-registers of computers 15a and 15b, respectively, divided in 7 consecutive I/Q spread signal portions (input data subsets) of 9 bits each, in the same manner as the PN portions described hereinabove. Each 9-bit portion of the I-component spread signal and the parallel 9-bit portion of the Q-component spread signal can be concatenated (for example in computer 15a) into an 18-bit I/Q word and the 7 I/Q words can be distributed (transmitted), in the same sequential index order as the reference PN sequence, to the 7 word-extension computers 15c-15i. At the conclusion of step 220 of operation, the stacks in computers 15c-15i will contain I and Q chip values in T-registers and PN sequence values in S-registers, appropriately aligned for correlation (in the same index order). Local partial correlation values can then be determined and accumulated according to steps 230 and 240, performed in computers 15c through 15i, all substantially at the same time, and results passed, for example, to computer 15c, wherein a correlation value Cv that is a sum of the partial correlation values can then be accumulated and compared in branch test step 250 to a threshold value Tv, and alternatively also to a lower threshold value Lv, as described hereinabove, to assess the degree of correlation and determine if the signal is acquired. Further alternatively, two comparisons, to a PN word and to a conjugate PN word, can be performed. If Cv does not exceed Tv, or alternatively is not below Lv, operation proceeds to step 260 wherein the signal chips are shifted forward by one, or more, bit position(s) in the T-registers of computers 15c-15i and suitably transferred as required along path 52, and a new I-component signal chip and corresponding new Q-component signal chip are read into bit position 0 of the T-registers of computers 15a and 15b, and suitably transferred to bit positions 0 and 10, respectively, of the T-register of computer 15c, thus providing a new subset of input data for comparison. If Cv exceeds the threshold, or alternatively is below the lower threshold, in step 250, acquisition of the spread signal is indicated (step 280); and the current alignment with respect to the reference PN sequence is the correct phase for de-spreading the received signal in further segments of 63 signal chips at a time, as described hereinabove.

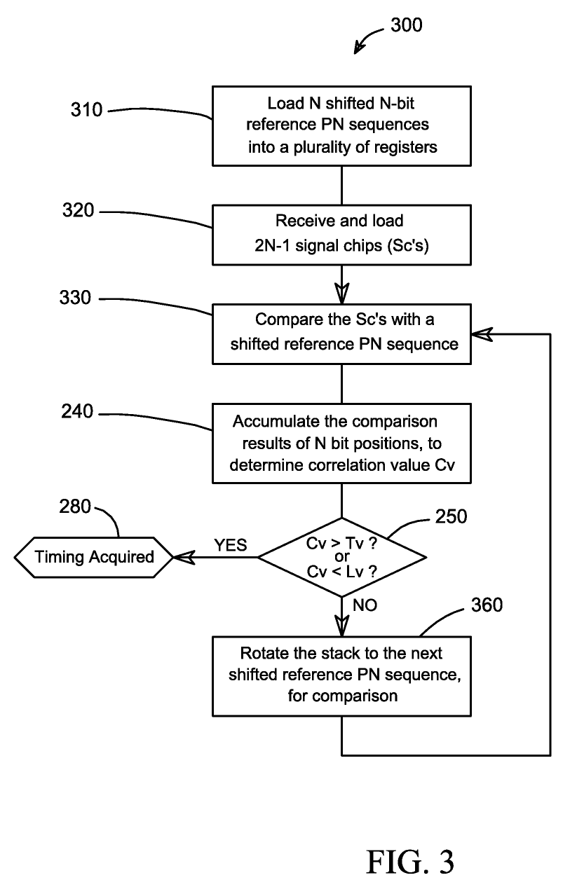

In a second embodiment of the inventive method, illustrated by a sequence of steps 300 shown in FIG. 3, N predetermined shifted reference PN sequences are stored, in load step 310, in the N registers of a correlation computer, for example, in the T-register and circular registers of the data stack of a SEAforth® computer, and sequentially recalled therefrom into the T-register (for example, by rotating the stack) in rotation step 360, instead of a PN sequence being shifted as described hereinabove, prior to the next comparison step 330. The spread signal segment of 2N-1 chips could be received and loaded in another register, for example, the S-register of the correlation computer, in receive step 320, prior to the first comparison performed in comparison step 330, and can remain in that register throughout the acquisition process. In case of a long reference PN sequence processed in portions in a plurality of correlation computers, rather than in one correlation computer, the 2N-1-bit spread signal segment could be stored in portions, in a series of S-registers in a set of word-extension correlation computers (as described hereinabove with reference to the example of N=63), and the N shifted PN sequences could be stored in corresponding portions, in the series of T-registers, circular registers, and memory registers, in the set of word-extension computers. The number of word-extension computers employed in this embodiment depends on the number of bits of the 2N-1-bit spread signal (and the PN sequence), that are held in one register, according to the application. The N-bit shifted PN sequences can be held in fewer computers of the set than the 2N-1-bit spread signal segment, or viewed from another perspective, some computers of the set do not hold any portions of some of the shifted PN words and thus can use fewer than N registers.

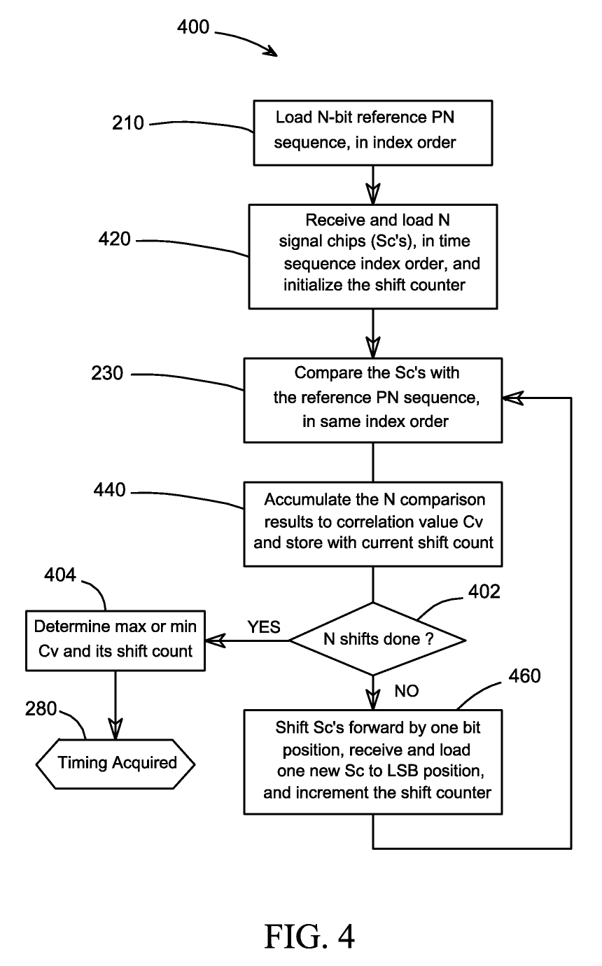

A third embodiment of the method of the invention is described by a sequence of signal processing steps 400 shown in FIG. 4, in flow diagram form. In this embodiment, correlation is assessed by finding the correlation values Cv for all N possible relative phases of the received signal and the reference PN sequence (assuming that the I- and Q-components have substantially the same relative phase), both for the PN word and the conjugate PN word if desired for the application, and determining the maximum or minimum Cv value and corresponding phase (the number of Sc shifts with respect to the PN sequence) at which the maximum or minimum occurs. The branch test step 402 simply checks a shift counter value against the length N of the reference PN sequence (in this example, N=63), and other aspects of operation remain substantially the same as in the embodiments described hereinabove, wherein the input data is divided into 9-bit portions and the I-component and Q-component of each portion are concatenated into 18-bit I/Q words. The load step 210 of operation of the FIG. 4 embodiment is identical to step 210 in the FIG. 2 embodiment. Receive step 420 is similar to step 220 in FIG. 2, but additionally includes initialization of a shift counter. Compare step 230 is identical to step 230 in the FIG. 2 embodiment. Accumulate step 440 is similar to step 240 in FIG. 2, but is additionally adapted to store (partial) Cv's and current shift count values, for example, in a stack register, and to transmit these periodically, for example, to computer 15c or another designated computer. In the SEAforth® implementation, Cv's (or partial Cv's) can be stored in the data stack registers of a correlation computer, and transferred after each 9 shifts to computer 15, thus enabling faster operation. For N=63, a 10-bit binary number can hold a Cv and a shift count value. The value of the shift counter can be initialized to 1 in step 420 and incremented by 1 each time the operation loops through step 460, which is substantially similar to step 260 in FIG. 2, but is additionally adapted to increment the shift counter. After 63 shifts have been completed, as determined by the shift count in step 402, a number of I-component signal chips equal to twice 63 less 1 (i.e., 125 signal chips) and the same number of Q-component signal chips have been received, and the correlation values Cv have been determined for all possible relative phases of the spread signal and the reference PN sequence. Thus, in this embodiment, operation can continue in the loop of steps 230 through 460 until N shifts have been recognized by branch step 402, and operation can then branch to step 404 (FIG. 4) wherein the largest (max) or smallest (min) correlation value Cv and the associated shift value can be determined, for example, in computer 15c by means of a suitable accumulating and sorting program, using the partial Cv values and shift count values determined and stored in the correlation computers, and transmitted therefrom to computer 15c. The shift count value of the largest (max) or smallest (min) Cv indicates the relative index alignment between the reference PN sequence and the received spread signal at which the signal has been “acquired”, and accordingly, what the correct phase is for de-spreading further N-bit segments of the received signal.

The process of shifting a subset of data, such as spread signal chips, or PN sequence values, forward by one bit position while holding another data subset fixed, as described hereinabove, is only one example of a great many techniques of scanning the relative alignment of two data subsets, to find a particular alignment, in this case a match or anti-match, and other techniques of shifting, by another pattern that can cover the same set of alignments, may be used with equal effect according to the invention. For example, a different order of shifting, or interleaved shifting, may be employed. For another example, the spread signal stream might be sampled at 2 bits per chip, rather than just 1 bit per chip as described hereinabove, and in that case the reference PN sequence can also have multi-bit representation, such as 2 bits per value, taking twice the number of register bits to store N-values of the PN sequence. Further in that case, shifts can be done 2 bits at a time, but the XOR operation to make the comparison between the received sequence and the reference sequence is identical, as is the accumulation of the partial Cv values. This can be extended, as well, to more bits per PN value.

A benefit of the invention is realized for long PN sequences when using a plurality of computers to process portions of the PN sequence for DSSS demodulation. Once a DSSS signal has been acquired, the received signal can be passed into correlation computers (such as word-extension computers 15c through 15i, for the example of N=63) in PN sequence-length subsets of data, without need of further chip-by-chip shifting and processing, as opposed to the case of the acquisition process described hereinabove. For quadrature RF modulation as described hereinabove, there are two parallel received signals corresponding to I and Q components. After acquisition, once all correlation computers are filled, the correlation value Cv (for both the I-component and the Q-component) can be directly determined, and will be found, for example, to be either large or small, which determines if the information signal bit is a “1” or “0” (separately for both components). Therefore, for de-spreading (demodulation), the correlation is only calculated once per data bit of the (lower data rate) information signal, with the (higher data rate, baseband) spread signal simply being passed through to fill the computers between the information signal bit transfer times. This method requires far less processing power than performing an acquisition on every signal chip, as is done during the acquisition process.

For a binary-modulated spread signal, concatenation and a second comparison with a conjugate PN word are not applicable, and a reference PN sequence (or a suitable portion of it) can comprise a PN word. After acquisition, correlation with a received spread signal segment having an equal number of bits, herein also referred to as data word, will produce either a match, or anti-match, corresponding to a 1 or 0 value of the binary information signal. It will be recognized by those skilled in the art that the embodiments described hereinabove with reference to a quadrature-modulated signal can be suitably simplified to be used also for acquisition and demodulation of a binary-modulated RF signal; and conversely, it will be recognized that embodiments of the invention described more clearly hereinbelow with reference to a binary-modulated signal, can be adapted, with suitable modifications generally as described hereinabove, to process also a quadrature-modulated signal, and also signals using other RF modulation techniques.

In an alternate, parallel acquisition embodiment of the method of the invention, a plurality of computers 15 can be employed for parallel acquisition of timing, for sufficiently short PN sequences as limited by available array size, whether the computers are on a single die, or multiple dies. It will be assumed here in the interest of clarity that binary modulation is used and, hence, the received signal includes one spread signal stream.

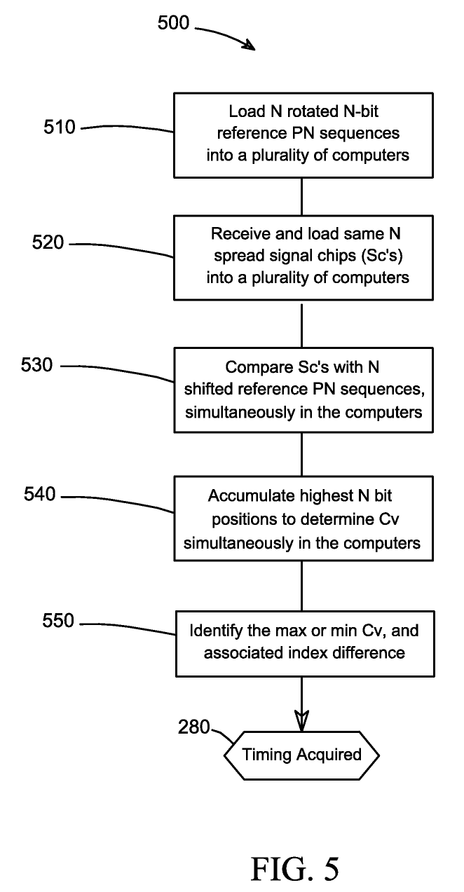

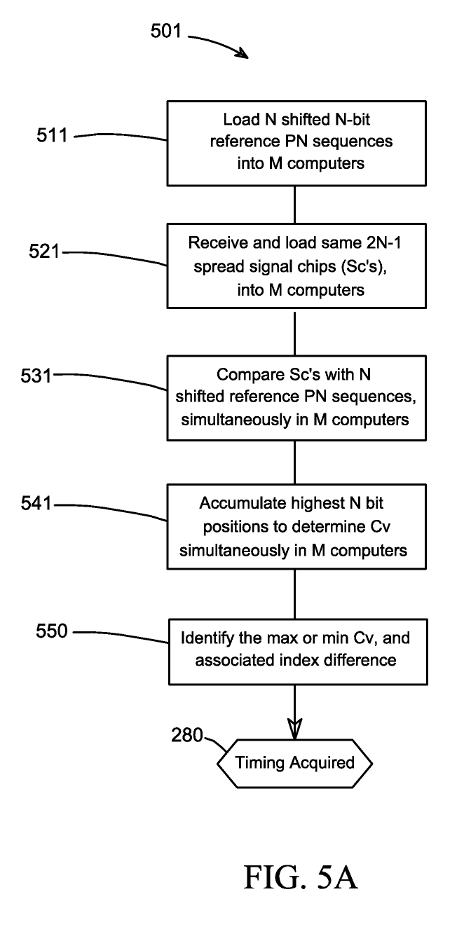

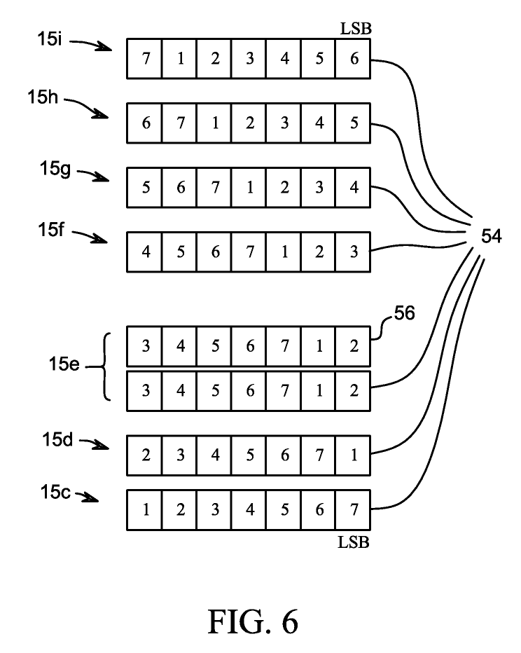

Operation of the array correlator 10 according to the parallel acquisition or fourth embodiment, may be described by a sequence of steps 500 shown in FIG. 5, in flow diagram form. It will be further assumed here, for clarity of description, that a repeating single symbol chip sequence is received during acquisition, and that the length N of the reference PN sequence is 7 bits. In load step 510 of the operation, a reference PN sequence can be loaded from external device 50 into computer 15p, therein termed PN word, and transmitted to 7 correlation computers 15c through 15i in a rotated manner, such that 7 different shifted PN words are loaded into the data stacks (initially into T-registers and subsequently pushed into S-registers). Each of the rotated PN words is a rotated version of the reference PN sequence, rotated by one index value (bit position) with respect to the PN word in an adjacent correlation computer, starting with the unrotated PN word in computer 15c, and rotating all values one bit toward MSB, as shown symbolically in FIG. 6. A data stack register 54 for each correlation computer 15c, 15d, . . . , 15i is symbolically depicted in the figure as a one-dimensional array with N bit positions. In receive step 520 of operation, a sequence of N consecutive spread signal chips (Scs) can be received and transferred from external device 40 to computer 15a, and transmitted to the data stack T-register as a spread signal (input data) word, in correlation computers 15c through 15i, substantially as described hereinabove with reference to step 220 shown in FIG. 2, with the exception that in the current embodiment the input data word is transmitted not to one computer but to a plurality of correlation computers (into the same bit positions in each computer). In the SEAforth® environment, when the data word is loaded into the T-register of a correlation computer, the shifted PN word currently in the T-register gets pushed into the S-register, without change of bit position. The T-registers of all correlation computers thus contain an identical N-bits long data word that includes a sequence of N consecutive chips of an N-chip repeating spread signal pattern that can match one of the rotated (and unrotated) reference PN sequences or its complement. An example of a spread signal chip index value sequence of a data word in the T-register 56 of computer 15e, that is aligned (in the same bit positions) with a rotated copy of the PN word in the S-register, is illustrated in FIG. 6, showing a phase shift or time difference of two chips between the unrotated PN word and the matching sequence in the data word. Accordingly, at the conclusion of step 520 of operation, the 7 correlation computers contain all 7 possible relative phases (index value shifts) of a 7-bit reference PN sequence that can produce a match or anti-match with a 7-bit data word that contains 7 consecutive spread signal chips of a repeating baseband signal sequence (of 1s, in this example).

In compare step 530, the data word is compared with a shifted PN word in each of the 7 correlation computers substantially simultaneously, in the SEAforth® environment by executing an XOR instruction. The correlation values (Cv's) can be determined, in accumulate step 540, by accumulating the comparison values in the N bit positions occupied by the data in each correlation computer by means of a suitable bit counting program operative in the computer. In identification step 550 the correlation values can be transmitted, for example, to computer 15c and sorted to find the maximum or minimum Cv and the associated index value (relative phase), and thus timing is acquired, as designated by end step 280. In this embodiment, further input data can be de-spread in subsets of length N after receiving and loading a number of spread signal chips indicated by the relative phase at acquisition.

In an alternate embodiment of the FIG. 5 parallel acquisition method, the steps 510 and 520 of the sequence of steps 500 could be modified so that an N-bit reference PN sequence, rather than an N bit subset of input data, is loaded into identical bit positions in N computers, and the N bits of input data (of a repeating single symbol sequence) are loaded into N computers in N rotated versions, for simultaneous correlation in N computers. This can have the advantage of faster operation than the first embodiment described hereinabove with reference to FIG. 2, if the comparison and accumulation steps are more time-consuming than the transmission time to distribute the input data to, and to collect the Cv values from, the correlation computers. Operation can then continue with step 530 onward, for completion of the acquisition process.

An alternate approach to the parallel acquisition method that is functionally equivalent, and adapted to acquire an arbitrary received spread signal, but perhaps not as fast, may be described by a sequence of steps 501 shown in FIG. 5A, in flow diagram form. This approach would place the reference PN sequences in 2N-1 shifted positions within a computer word, along with an indexing method that keeps track of where the offset is located. The steps in the process 501 are similar to those of the method 500 described with reference to FIG. 5, but require additional shifting of bits compared to that method, and thus may be not as efficient. In load step 511, N shifted versions of the N-bit reference PN sequence are loaded into a plurality of M computers, in the manner described with reference to FIG. 2A, for example, in the S-register. In receive step 521, a segment of 2N-1 consecutive received spread signal chips is loaded into the same computers, for example, in the T-register. It should be noted that the plurality M can comprise N computers if 2N-1 bits can be held in one register, and if 2N-1 is larger compared to the register (and word) size of the computers, M can be larger than N so that a shifted PN sequence and the received signal segment can be loaded into the S- and T-registers of a set of word extension computers, as will be further described hereinbelow. In compare step 531, the received signal segment is compared with a shifted reference PN sequence in the M computers simultaneously. In accumulate step 541, the correlation values (Cv's) can be determined by accumulating the comparison values in the N bit positions that correspond to the highest N bits of the shifted PN word, and excluding other bit positions, in each of the M computers, by means of a suitable bit counting program operative in the computer. The identification step 550 and Timing Acquired step 280 in method 501 are substantially similar to those in method 500, as described hereinabove.

The FIG. 5 parallel acquisition embodiment, mentioned hereinabove with the help of an example using a PN sequence length of 7 chips, can be extended to longer PN sequences by dividing a reference PN sequence into portions which can be loaded into a series of registers in a plurality of word-extension correlation computers of the array, and the portions can be processed in parallel in the computers, generally in the same manner as described hereinabove for computer 15c. The method 500, using rotated PN reference words, could be used as described above. For this case after each set of correlations has been completed in each computer, the entire sampled word in that computer is passed on to the next neighbor in the word-extension computers, and a new sampled word is loaded into the first computer in that chain, 15c. In other words, the sampled data can be passed as multiple bits or full words, not just as single bits down the word extension chain. The last word extension computer, 15i, drops its sampled word before accepting a new word from the previous computer in the set. The correlation process is then repeated as before. The partial Cv's are passed to another processor to accumulate into a set of total Cv's for all of the word extension computers, along with their index locations, and then tested to see if Cv exceeds or is below either Tv or Lv. If yes, then the index number indicates the correct timing for acquisition.

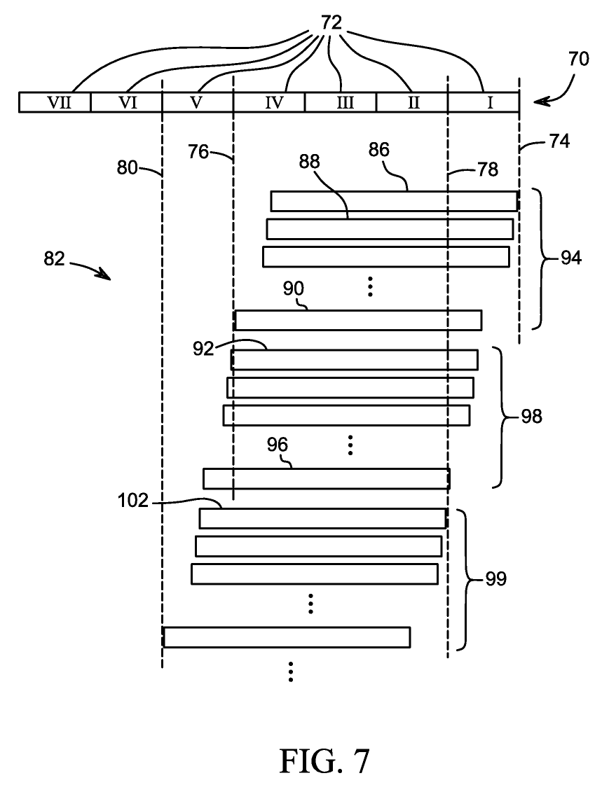

The FIG. 5A sample shifting embodiment of the parallel acquisition method, mentioned above for a 7-bit PN sequence, can also be extended to process longer PN sequences. For example, if the PN sequence length is 63, 125 bits of input data can be received and loaded into a plurality of computers for correlation with potentially a maximum of 63 shifted extended PN words, in order to obtain a match for acquisition. For an 18-bit computer word and register size, 7 registers, which can be, for example, the T-registers of 7 different word-extension computers 15 of a SEAforth® array, can hold a 125-bit subset (sequence) 70 of input data, as illustrated symbolically in FIG. 7. The input data subset 70 is divided into 7 consecutive portions held in a series of data stack registers 72 of a set of 7 word-extension computers, labeled by Roman numerals designating both the time sequential order of the data portions and the serial order of a word-extension computer; six of the data portions (in computers I through VI) are 18 bits long, and the last portion, in computer VII, is 17 bits long in this example. The registers are depicted in FIG. 7 as a concatenated array of rectangles, wherein each rectangle represents a data stack register 72, for example, the T-register, with LSB position on the right hand and MSB position on the left hand side. Dashed alignment lines 74, 76, 78, 80, which indicate the bounds of registers of the computers, are included in the figure to illustrate alignment of data in S- and T-registers; for example, the LSB positions of the S- and T-registers holding data portion I are proximal to line 74, on the left, the MSB position for the registers holding data portion I are proximal to line 78, on the right, and equivalent bit positions are assumed to align along vertical lines. As described hereinabove with reference to the sequence of steps 500, the received input data values are transmitted to and remain in identical bit positions, in this case, for example, in the T-registers, of each set of word-extension computers, during the acquisition process, and a plurality of N shifted extended PN words are held in the S-registers of the computers. The registers of a series are loaded in (time) sequence index order beginning with the first bit of the input data subset being transmitted to the LSB position and shifted left to higher bit positions (toward MSB), and to different word-extension computers of a set, in Roman numeral order. The input data chip with the lowest time sequence index value is in bit position 16 of the T-register of a word-extension computer VII, and the chip with the highest time sequence index value is in the LSB (0 bit) position of a word-extension computer I.

For efficient allocation of signal processing and computation resources of the array correlator 10 according to the parallel acquisition embodiment of the invention including the sequence of steps 501, it is important to recognize that all portions of a 2N-1 bits long input data subset will not be required for comparison in step 531 with an N-bits-long shifted extended PN word, and can be excluded from the accumulation process to determine correlation Cv in step 541, as described hereinabove with reference to FIG. 5A. A shifted PN word includes the reference PN sequence in its most significant N bits, and arbitrary values in lower bit positions. N bits of the PN sequence can be divided into Rnd(N/B) portions, each held in a register of a word-extension computer, wherein B is the portion length in bits and Rnd( ) designates rounding up to the nearest integer value. As the portions of a shifted extended PN word can fill a series of registers partially on both ends, or on one end, depending on the particular alignment and number of shifts, the number of word-extension computers in a set holding N bits for correlation in a series of registers is at most Rnd(N/B)+1 and at least Rnd(N/B), and accordingly, the number of computers M employed to correlate N shifted PN sequences in parallel, is at most N·(Rnd(N/B)+1) and at least N·Rnd(N/B), in this embodiment of the invention. In the current example, only 63 bit positions will be included in a correlation determination, and the portion length in a register is 18 bits, thus a set of 4 or 5 word-extension computers, that is, significantly less than 7, can be used for comparison of input data with each shifted extended PN word, as will be presently described with reference to the register loading diagram illustrated in FIG. 7. A plurality 82 of 63 shifted extended PN words in S-registers are symbolically depicted in FIG. 7 as horizontal bars, showing for purposes of clarity only the top 63 bits included in correlation determination, and aligned in bit positions with respect to the input data subset 70 as shown, and extending in sequence index order from left to right, in the same order as the input data subset. In the parallel acquisition embodiment, array correlator 10 includes a set of word-extension computers for each of the 63 shifted extended PN words, wherein the PN word and input data 70 are held for correlation. The unshifted extended PN word 86 is positioned starting with sequence index 63 in bit position 0 of the S-register of a word-extension computer I, then spans the S-registers of a set of word-extension computers I-IV, filling all 18 bit positions of the register in computers I-III, and 9 bit positions in computer IV, and ending with sequence index 1 in bit position 8 of the S-register of a word extension computer IV. Word 86 aligns with the portion of input data which is held in the same bit positions in the T-registers of the same computers. The shifted extended PN word 88 is positioned starting with sequence index 63 in bit position 1 of the S-register of a word-extension computer I, then spans the S-registers of a set of word extension computers I-IV, ending with sequence index 1 in bit position 9 in computer IV. Further shifted extended PN words are positioned, each by one bit position further toward MSB and computers VII, which hold input data chips with sequence index values 1-17 in the T-register, in bit positions 0-16. For example, shifted extended PN word 90 is positioned starting with sequence index 63 in bit position 9 of a computer I and ending with sequence index 1 in the MSB bit position 17 of a computer IV. With reference to alignment line 76, which is located between the MSB position of data stack registers of a computer IV and the LSB position of data stack registers of a computer V, it can be seen that the next shifted extended PN word 92 extends to the LSB position 0 of the next word-extension computer V. A first group 94 of 10 shifted extended PN words 86, 88, . . . , 90, which are shifted by 0-9 bit positions (from the unshifted position), can be held in only 4 word-extension computers I-IV, and accordingly, uses a total of 40 correlation computers. With reference to alignment line 78, shifted extended PN word 96, which is shifted 17 bit positions, is the last one to use computer I, and accordingly in a second group 98 of 8 extended PN words 92, . . . , 96, which are shifted by 10-17 bit positions, can be held in 5 word-extension computers I-V and accordingly, group 98 also uses 40 correlation computers. With reference to alignment line 80, the next group 99 of 10 extended PN words, beginning with shifted extended PN word 102, which are shifted by 18-27 bit positions, can each be held in 4 word-extension computers II-V, and again uses 40 correlation computers. The following group (not shown) includes again 8 shifted extended PN words, shifted by 28-35 bit positions, each using 5 word-extension computers II-VI; then another group (not shown) includes 10 shifted extended PN words, shifted by 36-45 bit positions, each using 4 word-extension computers III-VI; and still another group (not shown) includes 8 shifted extended PN words, shifted by 46-53 bit positions, each using 5 word-extension computers III-VII; and the last group (not shown) includes 9 extended PN words shifted by 54-62 bit positions, each using 4 word-extension computers IV-VII. Accordingly, in this embodiment the 63 shifted extended PN words to be compared in parallel to the input data portion 70 are divided into 7 groups (94, 98, 99, and four more, not shown) according to the word-extension computers in which they are held; the first, third, and fifth groups can each be held in 10 sets of 4 word-extension computers, the second, fourth, and sixth groups can each be held in 8 sets of 5 word-extension computers, and the last group can be held in 9 sets of 4 word-extension computers, thus in this embodiment a total of 276 correlation computers are used for fully parallel acquisition. In step 541, the comparison results can be accumulated, collected, and summed along the word-extension computers in a set, in each of the 63 sets of computers (holding 63 shifted extended PN words), and the match or anti-match and corresponding shift can determined, completing the acquisition process.

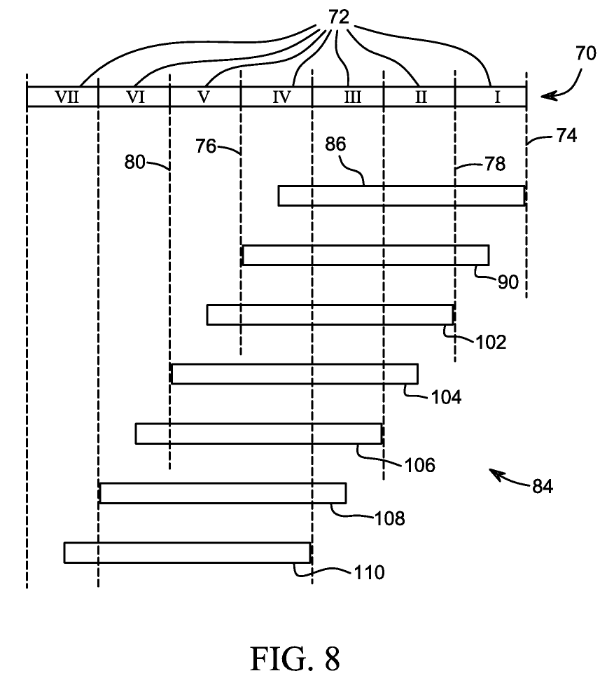

A hybrid method of acquisition, according to an embodiment of the invention, can include elements of the parallel and sequential methods of operation of the array correlator 10, which are described hereinabove. For a PN sequence length of 63, for example, and with reference to FIG. 8, and to the parallel acquisition embodiment described with reference to FIG. 7, a plurality 84 of 7 shifted extended PN words can be initially loaded into the S-registers of 7 sets of word-extension computers, and a 125-bit input data subset 70 described hereinabove can be loaded into the T-registers of the computers, for correlation and acquisition of timing. In this embodiment, the shifted extended PN words of plurality 84 differ by 9 shifts from each other, and each is held in a set of either 4 or 5 word-extension computers (in S-registers). In particular, unshifted extended PN word 86 is held in a first set of 4 word-extension computers I-IV; extended PN word 90, which is shifted by 9 bits, is held in a second set of 5 word-extension computers I-V; extended PN word 102, which is shifted by 18 bits, is held in a third set of 4 word-extension computers II-V; extended PN word 104, which is shifted by 27 bits, is held in a fourth set of 5 word-extension computers II-VI; extended PN word 106, which is shifted by 36 bits, is held in a fifth set of 4 word-extension computers III-VI; extended PN word 108, which is shifted by 45 bits, is held in a sixth set of 5 word-extension computers III-VII; and extended PN word 110, which is shifted by 54 bits, is held in a seventh set of 4 word-extension computers IV-VII. Accordingly, the 7 extended PN words specified hereinabove can be held in a total of 31 correlation computers, and the comparisons and accumulations to determine Cv can be performed substantially simultaneously in the computers, and Cv can be compared in a branch step of operation with an upper threshold value Tv and a lower threshold value Lv, generally according to the procedure described with reference to the alternate embodiments described hereinabove. If Cv does not exceed Tv or lie below Lv, the 7 shifted extended PN words can be shifted forward by 1 bit position in the S-registers (toward MSB) and transmitted to subsequent computers along a series of word-extension computers (toward word-extension computer VII) as required, and operation can loop back to comparisons and accumulations, and so on. With reference to the alignment lines 74, 76, etc., shown in FIG. 8 that 8 such shifts can be performed sequentially in time within the sets of word-extension computers specified hereinabove (for 9 alignment positions total, including the unshifted position in each set), and 7 at a time in parallel, in order to include all 63 possible alignments of the extended PN word which may be required to find a match or anti-match with the input data subset, to complete the acquisition process, using 31 correlation computers. If, in the branch step, Cv is found to be above Tv or below Lv, a match or anti-match of the input data has occurred with a particular shifted extended PN word, and the relative phase can be determined from the set of word-extension computers and the number of loop repetitions performed, and the acquisition process is completed. The inventive implementation of DSSS signal acquisition in a general-purpose multiprocessor array, and especially in an array on a single die, is especially powerful in the hybrid embodiment to provide for trading off parallel signal processing resource requirements of circuit area and operating power, with sequential cyclical performance of signal processing steps, over time, as required for the application, through suitable modification of the software program of instructions. Operation of the array correlator 10 can be adapted through software, for example, to load a plurality of 21 shifted PN words into the S-registers in 21 sets of word-extension computers, which differ by 3 shifts from each other, and operation can loop through a maximum of 3 shifts in each of the 21 sets in parallel, for acquisition in an application requiring higher speed and tolerant of higher power consumption during the process.

In an alternate embodiment of the hybrid acquisition method, after loading the reference PN sequence, and transmitting the plurality 84 of 7 shifted extended PN words to the S-register of each of the seven sets of word-extension computers as described hereinabove, 8 shifted extended PN words can be prepared from each of the plurality 84, and stored in data stack registers in each set, generally in the manner of step 310 of the sequence of steps 300 described hereinabove for the example of N=7. After the branch step, if Cv does not exceed Tv or lie below Lv, the next prepared shifted extended PN word in each set of word-extension computers can be retrieved and loaded in the S-register by suitably manipulating the stack, for example, by rotating the circular portion of the data stack (in a SEAforth® array), generally in the manner of step 360, and operation can loop back to comparisons and accumulations, and so on. In other respects, this embodiment is substantially similar to the first embodiment of the hybrid acquisition method described hereinabove.

While specific array correlator methods for DSSS timing acquisition for PN sequences of lengths seven and sixty-three have been discussed herein, the same methods can be extended to PN sequences longer than sixty-three. The method is not limited to implementation on one SEAforth® array, or a single die, and with appropriate circuit and software changes it may be extended to utilize, for example, a plurality of processor arrays that can be on a plurality of microchips.

The invention is described hereinabove with reference to embodiments using the Forth™ computer language, for illustrative purposes, not meant to be limiting. It should be noted that the invention can be practiced with equal effect in alternate embodiments with different computer word size and other such architecture aspects, and using other suitable computer languages, for example C++, C#, and appropriate compiled object code suitable for the computers of a multiprocessor die employed in such embodiment.

A yet further alternate embodiment, the hardware portion that is the smallest repeated element of array correlator 10 on die 25, may have a form that is different from a dual-stack computer with RAM and ROM memory, without departing from the spirit and scope of the invention. While in the embodiments described hereinabove, the smallest repeated hardware portion of die 25 (and array correlator 10) is a computer 15, in the yet further alternate embodiment the smallest repeated hardware portion can be, for example, a software-configurable set of computation, communication and memory resources, and sometimes also called a digital cell, internally connected, for example, through a switch, and directly connected to adjacent, neighboring hardware portions by single-drop buses, and further, adaptable by means of appropriate (system-level) instructions, suitably interleaved with array correlator software instructions, to appear to array correlator software as a fully functioning computer with its own memory, and alternatively, as a more limited computation, communication or memory resource, according to the array correlator instructions executing in a particular hardware portion location on the die—such that, by appropriate software (instructions), hardware portions can be configured (adapted) to operate as an array correlator 10, according to the embodiments of the invention described hereinabove. The invention can be practiced in computer systems with still other suitable parallel-distributed structure at the hardware level.

It is expected that there will be a great many applications for this method which have not yet been envisioned. Indeed, it is one of the advantages of the present invention that the inventive method may be adapted to a great variety of uses.

While the invention is herein described in the context of a PN sequence correlation process, for a received DSSS signal, the invention can be usefully applied also to other complex signal processing tasks, such as pattern recognition of serial data, for example, for identification and security applications, for high sensitivity analytical detection, and for medical diagnosis.

### INDUSTRIAL APPLICABILITY

The inventive array correlator 10, nodes 15, connections 20 and PN sequence correlation methods 200-501 and alternate processes are intended to be widely used in a great variety of communication applications. It is expected that they will be particularly useful in wireless applications where significant computing power and speed is required.

As discussed previously herein, the applicability of the present invention is such that the inputting information and instructions are greatly enhanced, both in speed and versatility. Also, communications between a computer array and other devices are enhanced according to the described method and means. Since the inventive array correlator 10, and method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

What is claimed is:

1. An apparatus for complex signal processing comprising a plurality of computers connected to at least two adjacent computers by at least two single drop buses each for loading communication with external devices through input/output (I/O) ports connected to peripheral computers of the array instructions and data, each computer having a plurality of circular registers for automatic cyclical overwriting after storing computer words to the stack, and indefinte cyclical re-storing of data that is retrieved (read) from the circular portion, at every reading from the stack.

2. An apparatus for complex signal processing as in claim 1, wherein the set of computers is embedded on one die.

3. An apparatus for complex signal processing as in claim 2, wherein said plurality of computers is an array of general purpose, independently functioning computers, which are directly connected to their physically closest neighboring computers, and wherein each computer has its own local memory that can hold substantially the major part of its program instructions, including the operating system.

4. An apparatus for complex signal processing as in claim 3, wherein at least some front end circuits for receiving electromagnetic signals selected from radiofrequency, microwave frequency and optical frequency of a direct spread spectrum receiver are included on the die.

5. An apparatus for complex signal processing as in claim 4, wherein the set of computers includes at most one computer and a register can hold an N-bit segment of the received spread signal.

6. The apparatus of claim 4, wherein the set of computers includes at most one computer and a register can hold a (2N-1)-bit segment of the received spread signal.

7. A method of sequential correlation of a received direct spread spectrum binary digital signal with a binary N-bits long pseudo-noise sequence, including the steps of:
loading the pseudo-noise sequence, in an index order; and, receiving and loading an indication of the received spread signal in the same index order; and,
comparing the loaded data to the received data to determine a comparison result;
accumulating the comparison results to determine a correlation value; and,
comparing said correlation value with a predetermined upper threshold value and a predetermined lower threshold value; and,
determining if the conditions precedent for timing acquisition are present and if they are indicating timing acquisition and ending the process, and if they are not proceeding to the next step; and,
shifting a value by at least one bit position, and
looping back to said comparing step of determining the correlation value; and.
continuing the process until timing is attained.

8. A method of parallel correlation of a received direct spread spectrum binary digital signal with a binary N-bits long pseudo-noise sequence as in claim 7; wherein said determining step is comprising going to a timing acquired condition if said correlation value is between said upper and lower threshold values, and continuing to the next step if it is not.

9. A method of parallel correlation of a received direct spread spectrum binary digital signal with a binary N-bits long pseudo-noise sequence as in claim 8, wherein said shifting step is at least one bit forward.

10. A method of parallel correlation of a received direct spread spectrum binary digital signal with a binary N-bits long pseudo-noise sequence as in claim 8 wherein said shifting step is one bit forward.

11. A method of parallel correlation of a received direct spread spectrum binary digital signal with a binary N-bits long pseudo-noise sequence as in claim 8, wherein said receiving step loads 2N-1 signal chips and shifting step is accomplished by rotating to the next loaded pseudo-nose sequence.

12. A method of parallel correlation of a received direct spread spectrum binary digital signal with a binary N-bits long pseudo-noise sequence as in claim 7, wherein said receiving step is further comprising initializing a shift counter and said accumulating step stores the current shift count with the accumulation value, and said determining step determines if a predetermined number of shifts have been accomplished and if N shifts have not been accomplished, shifting signal shifts one bit and incrementing said shift count.

13. A method of parallel correlation of a received direct spread spectrum binary digital signal with a binary N-bits long pseudo-noise sequence as in claim 12, further comprising the step of further determining the maximum correlation value and associated shift count if N shifts have been done as the final step in determining a timing acquired state.

14. A method of parallel correlation of a received direct spread spectrum binary digital signal with a binary N-bits long pseudo-noise sequence as in claim 12, further comprising the step of further determining the minimum correlation value and associated shift count if N shifts have been done as the final step in determining a timing acquired state.

15. A method of parallel correlation of a received direct spread spectrum binary digital signal with a binary N-bits long pseudo-noise sequence comprising the steps of:
loading a plurality of shifted versions of a reference pseudo-noise sequence into a plurality of sets of computers; and.
loading portions of a 2N-1 bit segment of the received spread signal into the plurality of series of sets of computers; and,
comparing said shifted versions of the pseudo-noise sequence and portions of a 2N-1 bit segment of the received spread signal to determine a comparison result; and,
accumulating the comparison results of the highest N bit positions to determine a correlation value for the set; and,
identifying a correlation value and an associated index difference to acquire the timing.

16. A method of parallel correlation of a received direct spread spectrum binary digital signal with a binary N-bits long pseudo-noise sequence as in claim 15, wherein said correlation value in said identifying step is a maximum correlation value.

17. A method of parallel correlation of a received direct spread spectrum binary digital signal with a binary N-bits long pseudo-noise sequence as in claim 15, wherein said correlation value in said identifying step is a minimum correlation value.

18. A method of parallel correlation of a received direct spread spectrum binary digital signal with a binary N-bits long pseudo-noise sequence as in claim 15, wherein said correlation value in said identifying step is a maximum correlation value.

19. A method of parallel correlation of a received direct spread spectrum binary digital signal with a binary N-bits long pseudo-noise sequence as in claim 15, wherein said pseudo-noise sequence is stored in a first register of each of said computers and said 2N-1 bit segment of the received spread signal is stored in a second register in each of said computers.

20. A method of parallel and hybrid correlation of a received direct spread spectrum binary digital signal with a binary N-bits long pseudo-noise sequence comprising the steps of:
loading a plurality of rotated versions of a reference pseudo-noise sequence into a plurality of sets of computers; and.
loading portions of a 2N-1 bit segment of the received spread signal into the plurality of series of sets of computers; and,
comparing said rotated versions of the pseudo-noise sequence and portions of a 2N-1 bit segment of the received spread signal to determine a comparison result; and,
accumulating the comparison results of the highest N bit positions to determine a correlation value for the set; and,
identifying a correlation value and an associated index difference to acquire the timing.

21. A method of parallel and hybrid correlation of a received direct spread spectrum binary digital signal with a binary N-bits long pseudo-noise sequence as in claim 20, comprising the further steps of:
further loading a plurality of shifted versions of a reference pseudo-noise sequence into a plurality of sets of computers; and.
further loading portions of a 2N-1 bit segment of the received spread signal into the plurality of series of sets of computers; and,
further comparing said shifted versions of the pseudo-noise sequence and portions of a 2N-1 bit segment of the received spread signal to determine a comparison result; and,
further accumulating the comparison results of the highest N bit positions to determine a correlation value for the set; and,
further identifying a correlation value and an associated index difference to acquire the timing.
